(19) United States
(12) Patent Application Publication
(10) Pub. No.: US 2024/0227807 A9
(43) Pub. Date: Jul. 11, 2024

(54) VEHICLE MOVING CONTROL APPARATUS, VEHICLE MOVING CONTROL METHOD, AND COMPUTER-READABLE STORAGE MEDIUM STORING VEHICLE MOVING CONTROL PROGRAM

(71) Applicant: TOYOTA JIDOSHA KABUSHIKI KAISHA, Toyota-shi (JP)

(72) Inventors: Hideki KAMATANI, Nagoya-shi (JP); Yusuke Tsuzuki, Toyota-shi (JP); Takahiro Narita, Tokyo (JP)

(73) Assignee: TOYOTA JIDOSHA KABUSHIKI KAISHA, Toyota-shi (JP)

(21) Appl. No.: 18/452,943

(22) Filed: Aug. 21, 2023

(30) Foreign Application Priority Data
Oct. 19, 2022 (JP) 2022-167522

(51) Int. Cl. B60W 30/18; B60W 60/00

(52) U.S. Cl. CPC B60W 30/18072; B60W 60/001; B60W 2710/244; B60W 2720/106

(57) ABSTRACT

A vehicle moving control apparatus executes a regeneration charge coasting control when a stored electricity amount is equal to or smaller than a first deceleration charge threshold while a deceleration condition for decelerating a vehicle is satisfied, and executes a normal coasting control when the stored electricity amount of is greater than the first deceleration charge threshold while the deceleration condition is satisfied.

### CROSS-REFERENCE TO RELATED APPLICATIONS

This application claims priority to Japanese patent application No. JP 2022-167522 filed on Oct. 19, 2022, the content of which is hereby incorporated by reference in its entirety.

### BACKGROUND

### Field

The present invention relates to a vehicle moving control apparatus, a vehicle moving control method, and a computer-readable storage medium storing a vehicle moving control program.

### Description of the Related Art

There is known a vehicle moving control apparatus which executes a following moving control to move an own vehicle, following a preceding vehicle. Also, there is known a vehicle moving control apparatus which executes the following moving control to decelerate the own vehicle by causing the own vehicle to coast in order to improve a fuel consumption (for example, see JP 4677945 B). This known vehicle moving control apparatus is configured to stop an activation of an internal combustion engine to cause the own vehicle to coast.

The vehicle is equipped with electric components such as an air conditioner and lights. The electric components are activated by using electricity stored in a battery of the vehicle. The electricity is generated by power output from the internal combustion engine, and the generated electricity is stored into the battery. In this regard, the known vehicle moving control apparatus stops the activation of the internal combustion engine while the known vehicle moving control apparatus causes the own vehicle to coast by the following moving control. Therefore, if the electric components are activated when the activation of the internal combustion engine is stopped, the electricity stored in the battery continues being decreased. As a result, a stored amount of the electricity stored in the battery may become excessively small. This is not preferred.

### SUMMARY

An object of the present invention is to provide a vehicle moving control apparatus, a vehicle moving control method, and a computer-readable storage medium storing a vehicle moving control program which can prevent the stored amount of the electricity stored in an electricity storage device such as the battery from becoming excessively small when an activation of a power source such as the internal combustion engine is stopped, and the own vehicle is caused to coast.

A vehicle moving control apparatus according to the present invention comprises an electronic control unit configured to execute an autonomous moving control for autonomously accelerating or decelerating a vehicle. The autonomous moving control includes an acceleration control and a coasting control. The acceleration control is a control to accelerate the vehicle by (i) activating a power source of the vehicle to generate power and (ii) accelerating the vehicle by the generated power. The coasting control is a control to cause the vehicle to coast by stopping an activation of the power source. The electronic control unit is further configured to execute a regeneration charge coasting control as the coasting control when a stored amount of electricity stored in an electricity storage device of the vehicle is equal to or smaller than a first deceleration charge threshold while a deceleration condition for decelerating the vehicle is satisfied. The regeneration charge coasting control is a control to cause the vehicle to coast and store the electricity into the electricity storage device by (i) stopping the activation of the power source, (ii) performing a regeneration of moving energy of the vehicle by an electricity generation device of the vehicle to generate the electricity, and (iii) storing the generated electricity into the electricity storage device. The electronic control unit is further configured to execute a normal coasting control as the coasting control when the stored amount of the electricity is greater than the first deceleration charge threshold while the deceleration condition is satisfied. The normal coasting control is a control to cause the vehicle to coast by stopping the activation of the power source without performing the regeneration of the moving energy of the vehicle.

With the vehicle moving control apparatus according to the present invention, when the stored amount of the electricity becomes small (i.e., the stored amount of the electricity becomes equal to or smaller than the first deceleration charge threshold) while the deceleration condition is satisfied, the regeneration charge coasting control is executed as the coasting control. Thereby, while the activation of the power source is stopped, and the vehicle is caused to coast, the electricity is generated by the regeneration of the moving energy of the vehicle, and the generated electricity is stored into the electricity storage device. Thus, the stored amount of the electricity can be prevented from becoming excessively small even when the activation of the power source is stopped, and the vehicle is caused to coast.

According to an aspect of the present invention, the electronic control unit may be configured to execute a power charge moving control when the stored amount of the electricity is equal to or smaller than a second deceleration charge threshold smaller tha n the first deceleration charge threshold while the deceleration condition is satisfied. The power charge moving control may be a control to cause the vehicle to move by (i) activating the power source to generate the power, (ii) activating the electricity generation device by the generated power to generate the electricity, and (iii) storing the generated electricity into the electricity storage device. The electronic control unit may be further configured to execute the regeneration charge coasting control when the stored amount of the electricity is equal to or smaller than the first deceleration charge threshold and greater than the second deceleration charge threshold while the deceleration condition is satisfied.

An electric load such as an electric component of the vehicle may consume the electricity stored in the electricity storage device while the regeneration charge coasting control is executed. Therefore, the stored amount of the electricity continues to be decreased even when the electricity generated by the regeneration of the moving energy of the vehicle is stored into the electricity storage device. Thereby, the stored amount of the electricity may become excessively small.

With the vehicle moving control apparatus according to this aspect of the present invention, when the stored amount of the electricity becomes excessively small (i.e., the stored amount of the electricity becomes equal to or smaller than the second deceleration charge threshold) while the regeneration charge coasting control is executed, the power charge moving control is executed. Thereby, the power source is activated to generate the power, the electricity generation device is activated by the generated power to generate the electricity, and the generated electricity is stored into the electricity storage device. Thereby, the stored amount of the electricity can be prevented from becoming excessively small.

According to another aspect of the present invention, the electronic control unit may be configured to execute the regeneration charge coasting control so as to store an amount of the electricity depending on an amount of the electricity consumed from the electricity storage device by at least one electric load of the vehicle.

As described above, the electric load such as the electric component of the vehicle may consume the electricity stored in the electricity storage device while the regeneration charge coasting control is executed. In this case, the stored amount of the electricity can be increased early to the first deceleration charge threshold by increasing the amount of the electricity generated by the regeneration charge coasting control. However, in this case, a deceleration rate of the vehicle increases. Thus, a driver of the vehicle may feel a discomfort. On the other hand, it is effective to generate an amount of the electricity meeting the amount of the electricity consumed from the electricity storage device by the electric load, and store the generated electricity into the electricity storage device in order to prevent the stored amount of the electricity from becoming excessively small while the activation of the power source is stopped.

With the vehicle moving control apparatus according to this aspect of the present invention, the regeneration charge coasting control is executed so as to generate the amount of the electricity depending on the amount of the electricity consumed from the electricity storage device by the electric load of the vehicle. Therefore, the stored amount of the electricity can be prevented from becoming excessively small without generating the excessive deceleration rate of the vehicle which may cause the driver to feel a discomfort.

According to further another aspect of the present invention, the electronic control unit may be configured to limit a generated amount of the electricity generated by the regeneration of the moving energy of the vehicle by the electricity generation device so as to maintain a deceleration rate of the vehicle equal to or smaller than a predetermined deceleration rate while the regeneration charge coasting control is executed.

As described above, it is effective to increase the amount of the electricity generated by the regeneration charge coasting control in order to increase the stored amount of the electricity to the first deceleration charge threshold early. However, in this case, the deceleration rate of the vehicle increases. Thus, the driver may feel a discomfort.

With the vehicle moving control apparatus according to this aspect of the present invention, the regeneration charge coasting control is executed to limit the amount of the electricity generated by the regeneration of the moving energy of the vehicle so as to maintain the deceleration rate of the vehicle equal to or smaller than the predetermined deceleration rate. Thus, the stored amount of the electricity can be prevented from becoming excessively small without generating the excessive deceleration rate of the vehicle which leads to a discomfort of the driver.

According to further another aspect of the present invention, the power source may include an internal combustion engine. In this aspect, the electronic control unit may be configured to execute a power charge acceleration control as the acceleration control when the stored amount of the electricity is equal to or smaller than an acceleration charge threshold while an acceleration condition for accelerating the vehicle is satisfied. The power charge acceleration control may be a control to accelerate the vehicle and store the electricity into the electricity storage device by (i) activating the internal combustion engine to generate the power, (ii) activating the electricity generation device to generate the electricity by a part of the generated power, (iii) storing the generated electricity into the electricity storage device, and (iv) accelerating the vehicle by the remaining generated power. The electronic control unit may be configured to extend a time of executing the power charge acceleration control such that the time of executing the power charge acceleration control increases as the stored amount of the electricity decreases.

It is effective to store the enough amount of the electricity into the electricity storage device while the acceleration control is executed in order to prevent the stored amount of the electricity from becoming excessively small while the coasting control is executed.

With the vehicle moving control apparatus according to this aspect of the present invention, the power charge acceleration control is executed as the acceleration control when the stored amount of the electricity becomes small (i.e., the stored amount of the electricity becomes equal to or smaller than the acceleration charge threshold) while the acceleration condition is satisfied. Thereby, the internal combustion engine is activated to generate the power, the electricity is generated by a part of the generated power, the generated electricity is stored into the electricity storage device, and the vehicle is accelerated by the remaining generated power. In addition, while the power charge acceleration control is executed, the time of executing the power charge acceleration control increases as the stored amount of the electricity decreases. Thus, the enough amount of the electricity can be stored into the electricity storage device while the acceleration control is executed. Therefore, the stored amount of the electricity can be prevented from becoming excessively small while the coasting control is executed.

According to further another aspect of the present invention, the electronic control unit may be configured to execute a power charge acceleration control as the acceleration control when the stored amount of the electricity is equal to or smaller than an acceleration charge threshold while an acceleration condition for accelerating the vehicle is satisfied. The power charge acceleration control may be a control to accelerate the vehicle and store the electricity into the electricity storage device by (i) activating the power source to generate the power, (ii) activating the electricity generation device to generate the electricity by a part of the generated power, (iii) storing the generated electricity into the electricity storage device, and (iv) accelerating the vehicle by the remaining gene rated power.

As described above, it is effective to store the enough amount of the electricity into the electricity storage device while the acceleration control is executed in order to prevent the stored amount of the electricity from becoming excessively small.

With the vehicle moving control apparatus according to this aspect of the present invention, the power charge acceleration control is executed as the acceleration control when the stored amount of the electricity becomes small (i.e., the stored amount of the electricity becomes equal to or smaller than the acceleration charge threshold) while the acceleration condition is satisfied. Thereby, the power source is activated to generate the power, the electricity is generated by a part of the generated power, the generated electricity is stored into the electricity storage device, and the vehicle is accelerated by the remaining generated power. Thus, the enough amount of the electricity is stored into the electricity storage device while the acceleration control is executed. Therefore, the stored amount of the electricity can be prevented from becoming excessively small while the coasting control is executed.

According to further another aspect of the present invention, the electronic control unit may be configured to set the acceleration charge threshold such that the acceleration charge threshold decreases as a moving speed of the vehicle increases.

When the moving speed of the vehicle is great, the great amount of the electricity can be acquired by the regeneration of the moving energy of the vehicle. Therefore, the stored amount of the electricity can be sufficiently increased by the regeneration of the moving energy of the vehicle while the coasting control is executed later without generating the electricity by the power generated by the power source while the acceleration control is executed. In addition, the amount of energy consumed by the power source can be decreased if a generation of the electricity by the power generated by the power source, is not performed.

With the vehicle moving control apparatus according to this aspect of the present invention, the acceleration charge threshold is small when the moving speed of the vehicle is great. Therefore, the generation of the electricity by the power generated by the power source is not performed until the stored amount of the electricity becomes small when the moving speed of the vehicle is great while the acceleration control is executed. Thus, the stored amount of the electricity can be prevented from becoming excessively small, and the amount of the energy consumed by the power source can be reduced.

According to further another aspect of the present invention, the electronic control unit may be configured to set the acceleration charge threshold such that the acceleration charge threshold when the vehicle is predicted to move on a downward slope, based on map information and a predicted moving route of the vehicle, is smaller than the acceleration charge threshold when the vehicle is not predicted to move on the downward slope, based on the map information and the predicted moving route of the vehicle.

When the vehicle will move on the downward slope soon, the enough amount of the electricity can be stored into the electricity storage device by generating the electricity by the regeneration of the moving energy of the vehicle while the vehicle moves on the downward slope even if the stored amount of the electricity becomes small while the acceleration control is executed. Therefore, even if the generation of the electricity by the power generated by the power source is not performed while the acceleration control is executed, the stored amount of the electricity can be sufficiently increased by generating the electricity by the later regeneration of the moving energy of the vehicle while the vehicle moves on the downward slope, and the coasting control is executed. In this case, the amount of the energy consumed by the power source can be reduced since the generation of the electricity by the power generated by the power source is not performed.

With the vehicle moving control apparatus according to this aspect of the present invention, when it is predicted that the vehicle moves on the downward slope, the acceleration charge threshold is set to a small value, compared with when it is not predicted that the vehicle moves on the downward slope. Therefore, when it is predicted that the vehicle moves on the downward slope while the acceleration control is executed, the generation of the electricity by the power generated by the power source is not performed until the stored amount of the electricity becomes small. Thus, the stored amount of the electricity can be prevented from becoming excessively small, and the amount of the energy consumed by the power source can be reduced.

A vehicle moving control method according to the present invention is a method of executing an autonomous moving control for autonomously accelerating or decelerating a vehicle. The autonomous moving control includes an acceleration control and a coasting control. The acceleration control is a control to (i) activate a power source of the vehicle to generate power and (ii) accelerate the vehicle by the generated power. The coasting control is a control to (i) stop activating the power source and (ii) cause the vehicle to coast. The vehicle moving control method according to the present invention comprises a step of executing a regeneration charge coasting control as the coasting control when a stored amount of electricity stored in an electricity storage device of the vehicle is equal to or smaller than a first deceleration charge threshold while a deceleration condition for decelerating the vehicle is satisfied. The regeneration charge coasting control is a control to (i) stop activating the power source and cause the vehicle to coast, (ii) generate the electricity by performing a regeneration of moving energy of the vehicle by an electricity generation device of the vehicle, and (iii) store the generated electricity into the electricity storage device. The vehicle moving control method according to the present invention further comprises a step executing a normal coasting control as the coasting control when the stored amount of the electricity is greater than the first deceleration charge threshold while the deceleration condition is satisfied. The normal coasting control is a control to (i) stop activating the power source and cause the vehicle to coast without performing the regeneration of the moving energy of the vehicle.

With the vehicle moving control method according to this aspect of the present invention, for the reasons described above, the stored amount of the electricity can be prevented from becoming excessively small even when the activation of the power source is stopped, and the vehicle is caused to coast.

A computer-readable storage medium according to the present invention stores a vehicle moving control program which executes an autonomous moving control for autonomously accelerating or decelerating a vehicle. The autonomous moving control includes an acceleration control and a coasting control. The acceleration control is a control to (i) activate a power source of the vehicle to generate power and (ii) accelerate the vehicle by the generated power. The coasting control is a control to (i) stop activating the power source and (ii) cause the vehicle to coast. The vehicle moving control program is configured to execute a regeneration charge coasting control as the coasting control when a stored amount of electricity stored in an electricity storage device of the vehicle is equal to or smaller than a first deceleration charge threshold while a deceleration condition for decelerating the vehicle is satisfied. The regeneration charge coasting control is a control to (i) stop activating the power source and cause the vehicle to coast, (ii) generate the electricity by performing a regeneration of moving energy of the vehicle by an electricity generation device of the vehicle, and (iii) store the generated electricity into the electricity storage device. The vehicle moving control program is further configured to execute a normal coasting control as the coasting control when the stored amount of the electricity is greater than the first deceleration charge threshold while the deceleration condition is satisfied. The normal coasting control is a control to (i) stop activating the power source and cause the vehicle to coast without performing the regeneration of the moving energy of the vehicle.

With the computer-readable storage medium storing a vehicle moving control program according to the present invention, for the reasons described above, the stored amount of the electricity can be prevented from becoming excessively small even when the activation of the power source is stopped, and the vehicle is caused to coast.

Elements of the invention are not limited to elements of embodiments and modified examples of the invention described with reference to the drawings. The other objects, features and accompanied advantages of the invention can be easily understood from the embodiments and the modified examples of the invention.

### BRIEF DESCRIPTION OF THE DRAWINGS

FIG. 1 is a view which shows a vehicle moving control apparatus according to an embodiment of the present invention.

FIG. 2 is a view which shows a vehicle or an own vehicle installed with the vehicle moving control apparatus according to the embodiment of the present invention.

FIG. 3A is a view which shows a scene that there is a preceding vehicle ahead of the own vehicle.

FIG. 3B is a view which shows a scene that there is no preceding vehicle ahead of the own vehicle.

FIG. 4 is a view which shows a relationship between an engine power and an energy efficiency of an internal combustion engine, and a relationship between a motor power and an energy efficiency of a second motor generator.

FIG. 5A is a view which shows a scene that there is no preceding vehicle ahead of the own vehicle, and there is a following vehicle behind the own vehicle.

FIG. 5B is a view which shows a scene that there is the preceding vehicle ahead of the own vehicle, and there is the following vehicle behind the own vehicle.

FIG. 6 is a view which shows a time chart showing changes of an engine output power, a battery-stored electricity amount, etc.

FIG. 7 is a view which shows a relationship between an own vehicle moving speed and an acceleration charge threshold.

FIG. 8 is a view which shows a flowchart of a routine executed by the vehicle moving control apparatus according to the embodiment of the present invention.

FIG. 9 is a view which shows a flowchart of a routine executed by the vehicle moving control apparatus according to the embodiment of the present invention.

FIG. 10 is a view which shows a flowchart of a routine executed by the vehicle moving control apparatus according to the embodiment of the present invention.

### DESCRIPTION OF THE EMBODIMENTS

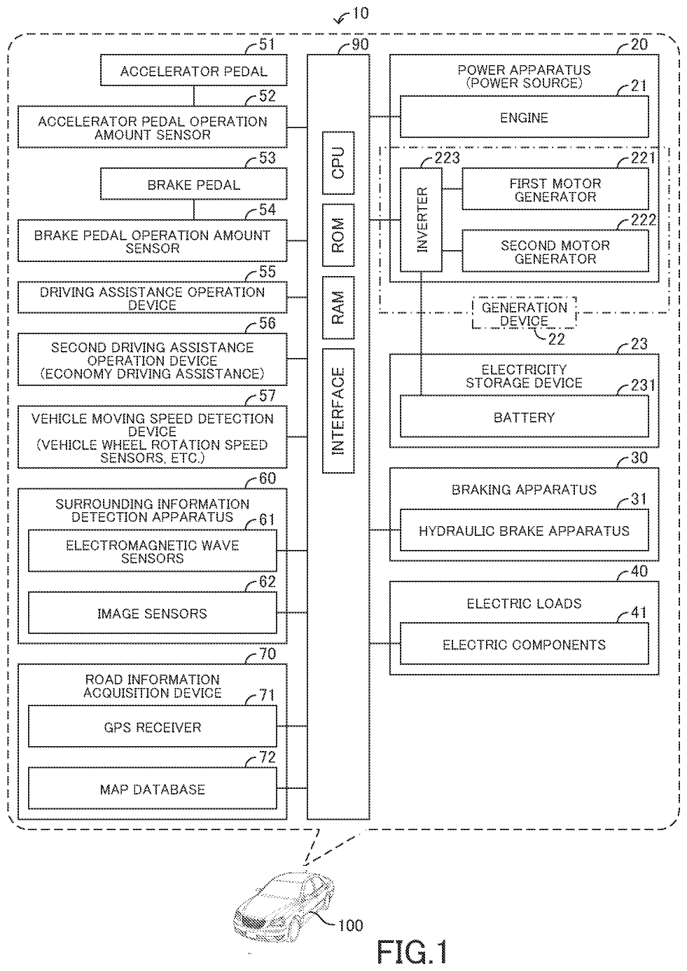

Below, a vehicle moving control apparatus according to an embodiment of the present invention will be described with reference to the drawings. The vehicle moving control apparatus 10 will be described with an example that an operator of an own vehicle 100 is a driver of the own vehicle 100, i.e., a person who is in the own vehicle 100 and drives the own vehicle 100. Therefore, in this embodiment, the vehicle moving control apparatus 10 is installed on the own vehicle 100 as shown in FIG. 1.

In this regard, the operator of the own vehicle 100 may be a remote operator of the own vehicle 100, i.e., a person who is not in the own vehicle 100 and remotely drives the own vehicle 100. When the operator of the own vehicle 100 is the remote operator, the own vehicle 100 and a remote operation equipment provided outside of the own vehicle 100 for the remote operator to remotely operate the own vehicle 100, are both installed with the vehicle moving control apparatuses 10. In this case, functions of the vehicle moving control apparatus 10 described below are realized by the vehicle moving control apparatus 10 installed on the own vehicle 100 and the vehicle moving control apparatus 10 installed on the remote operation equipment.

<ECU>

The vehicle moving control apparatus 10 includes an ECU 90 as a control device. The ECU 90 is an electronic control unit. The ECU 90 includes a microcomputer as a main component. The microcomputer includes a CPU, a ROM, a RAM, a non-volatile memory, and an interface. The CPU is configured or programmed to realize various functions by executing instructions, programs, or routine stored in the ROM. In this embodiment, the vehicle moving control apparatus 10 includes one ECU. However, the vehicle moving control apparatus 10 may include a plurality of the ECUs and execute the functions described below by the ECUs, respectively.

<Internal Combustion Engine, Etc.>

As shown in FIG. 1, the own vehicle 100 is installed with an internal combustion engine 21, a first motor generator 221, a second motor generator 222, and an inverter 223. The internal combustion engine 21 and the inverter 223 are electrically connected to the ECU 90. The inverter 223 is electrically connected to the first motor generator 221 and the second motor generator 222.

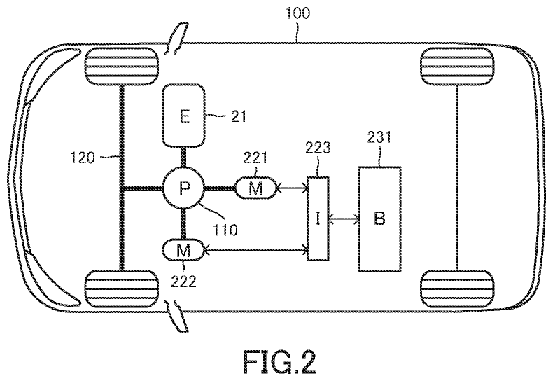

As shown in FIG. 2, the own vehicle 100 is installed with a power distribution device 110. The power distribution device 110 is a device which changes a transmitting line of transmitting power or energy between the internal combustion engine 21, the first motor generator 221, the second motor generator 222, and a driving shaft 120. The power distribution device 110 is connected to the internal combustion engine 21, the first motor generator 221, the second motor generator 222, and the driving shaft 120. In particular, the power distribution device 110 is comprised of a planetary gear mechanism. A sun gear of the planetary gear mechanism is operably connected to a crank shaft, i.e., an output shaft of the internal combustion engine 21. Planetary gears of the planetary gear mechanism are operably connected to an input-output shaft of the first motor generator 221. A ring gear of the planetary gear mechanism is operably connected to an input-output shaft of the second motor generator 222 and the driving shaft 120.

As shown in FIG. 2, the own vehicle 100 is installed with a battery 231. The battery 231 is electrically connected to the inverter 223. The battery 231 is an electricity storage device 23 which stores electricity.

The ECU 90 controls a magnitude of power generated by the internal combustion engine 21 by controlling an activation of the internal combustion engine 21. The ECU 90 can input engine power (i.e., the power generated by the internal combustion engine 21) to the driving shaft 120 via the power distribution device 110 by controlling an operation state of the power distribution device 110. That is, the ECU 90 can apply the engine power to the own vehicle 100 as a driving force for moving the own vehicle 100. Further, the ECU 90 inputs the engine power to the first motor generator 221 via the power distribution device 110 to activate the first motor generator 221 by controlling the operation state of the power distribution device 110. As can be understood, the internal combustion engine 21 is a power apparatus 20 as a power source.

It should be noted that the ECU 90 can control a proportion of the engine power input to the driving shaft 120 and the engine power input to the first motor generator 221 by controlling the operation state of the power distribution device 110.

When the engine power is input to the first motor generator 221, the first motor generator 221 generates the electricity. The generated electricity is stored into the battery 231 via the inverter 223. Therefore, the first motor generator 221 is an electricity generation device 22 which generates the electricity. The ECU 90 can control an electricity amount of the electricity generated by the first motor generator 221 by controlling a magnitude of the engine power input to the first motor generator 221 by controlling the operation state of the power distribution device 110.

Further, the ECU 90 can supply the electricity from the battery 231 to the first motor generator 221 by controlling an operation state of the inverter 223. When the electricity is supplied to the first motor generator 221, the first motor generator 221 generates power. Therefore, the first motor generator 221 is also the power apparatus 20 as the power source. The ECU 90 can control a magnitude of the power generated by the first motor generator 221 by controlling the electricity amount of the electricity supplied from the battery 231 to the first motor generator 221 by controlling the operation state of the inverter 223.

For example, the ECU 90 can start the activation of the internal combustion engine 21 by supplying the electricity to the first motor generator 221 and inputting the power generated by the first motor generator 221 to the internal combustion engine 21 via the power distribution device 110. In this case, the first motor generator 221 functions as a so-called starter motor.

Further, the ECU 90 can supply the electricity from the battery 231 to the second motor generator 222 by controlling the operation state of the inverter 223. When the electricity is supplied to the second motor generator 222, the second motor generator 222 generates power. Therefore, the second motor generator 222 is the power apparatus 20 as the power source. The ECU 90 can control a magnitude of the power generated by the second motor generator 222 by controlling the electricity amount of the electricity supplied from the battery 231 to the second motor generator 222 by controlling the operation state of the inverter 223.

The power generated by the second motor generator 222 is input to the driving shaft 120 via the power distribution device 110. That is, the ECU 90 can apply the power generated by the second motor generator 222 to the own vehicle 100 as the driving force for moving the own vehicle 100.

Further, the ECU 90 can input a moving energy of the own vehicle 100 to the second motor generator 222 via the power distribution device 110 by controlling the operation state of the power distribution device 110. When the moving energy is input to the second motor generator 222, the second motor generator 222 generates the electricity. In other words, the second motor generator 222 generates the electricity by regenerating the moving energy of the own vehicle 100. Therefore, the second motor generator 222 is also the electricity generation device 22 which generates the electricity. The ECU 90 can control an electricity amount of the electricity generated by the second motor generator 222 by controlling an amount of the moving energy of the own vehicle 100 input to the second motor generator 222 by controlling the operation state of the power distribution device 110.

In this embodiment, the power apparatus 20 includes the internal combustion engine 21, the first motor generator 221, and the second motor generator 222 as the power sources. In this regard, the power apparatus 20 may include the internal combustion engine and one motor generator as the power sources. Further, the power apparatus 20 may include only the internal combustion engine as the power source. In this case, the own vehicle 100 is installed with at least one generator as the electricity generation device.

<Braking Apparatus>

Further, the own vehicle 100 is installed with a braking apparatus 30. The braking apparatus 30 is a braking apparatus which applies a braking force to the own vehicle 100. In this embodiment, the braking apparatus 30 includes a hydraulic brake apparatus 31. The braking apparatus 30 is electrically connected to the ECU 90. The ECU 90 is configured to control the braking force applied to the own vehicle 100 by the braking apparatus 30.

<Sensors, Etc.>

Further, the own vehicle 100 is installed with an accelerator pedal 51, an accelerator pedal operation amount sensor 52, a brake pedal 53, a brake pedal operation amount sensor 54, a driving assistance operation device 55, a second driving assistance operation device 56, a vehicle moving speed detection device 57, and a surrounding information detection apparatus 60.

<Accelerator Pedal, Etc.>

The accelerator pedal 51 is a device which is operated by the driver to accelerate the own vehicle 100. The accelerator pedal operation amount sensor 52 is a device which detects an operation amount of the accelerator pedal 51. It should be noted that when the operator of the own vehicle 100 is the remote operator of the own vehicle 100, the accelerator pedal 51 and the accelerator pedal operation amount sensor 52 are installed on the remote operation equipment.

The accelerator pedal operation amount sensor 52 is electrically connected to the ECU 90. The ECU 90 acquires the operation amount of the accelerator pedal 51 as an accelerator pedal operation amount AP by the accelerator pedal operation amount sensor 52. The ECU 90 calculates an acceleration rate of the own vehicle 100 requested by the driver as a driver request acceleration rate Ga_driver, based on the accelerator pedal operation amount AP. The ECU 90 executes a normal moving control to control the driving force output from the power apparatus 20 so as to realize the driver request acceleration rate Ga_driver when the driver request acceleration rate Ga_driver is greater than zero except that the ECU 90 executes an autonomous moving control or an automatic driving control described later.

<Brake Pedal, Etc.>

The brake pedal 53 is a device which is operated by the driver to decelerate the own vehicle 100. The brake pedal operation amount sensor 54 is a device which detects an operation amount of the brake pedal 53. It should be noted that when the operator of the own vehicle 100 is the remote operator of the own vehicle 100, the brake pedal 53 and the brake pedal operation amount sensor 54 are installed on the remote operation equipment.

The brake pedal operation amount sensor 54 is electrically connected to the ECU 90. The ECU 90 acquires the operation amount of the brake pedal 53 as a brake pedal operation amount BP by the brake pedal operation amount sensor 54. The ECU 90 calculates a deceleration rate of the own vehicle 100 requested by the driver as a driver request deceleration rate Gd_driver, based on the brake pedal operation amount BR The ECU 90 executes the normal moving control to control the braking force applied to the own vehicle 100 from the braking apparatus 30 so as to realize the driver request deceleration rate Gd_driver when the driver request deceleration rate Gd_driver is greater than zero except that the ECU 90 executes the autonomous moving control described later.

<Driving Assistance Operator, Etc.>

Further, the own vehicle 100 is installed with the driving assistance operation device 55 and the second driving assistance operation device 56. It should be noted that when the operator of the own vehicle 100 is the remote operator of the own vehicle 100, the driving assistance operation device 55 and the second driving assistance operation device 56 are installed on the remote operation equipment.

<Driving Assistance Operator>

The driving assistance operation device 55 is a device such as a button or a switch which is operated by the driver. The driver can request the vehicle moving control apparatus 10 to execute the autonomous moving control described later or stop executing the autonomous moving control by operating the driving assistance operation device 55.

The driving assistance operation device 55 is electrically connected to the ECU 90. When the driving assistance operation device 55 is operated while the ECU 90 does not execute the autonomous moving control, the ECU 90 determines that the autonomous moving control is requested to be executed. Thereafter, the ECU 90 keeps determining that the autonomous moving control is requested to be executed as far as the driving assistance operation device 55 is not operated. On the other hand, when the driving assistance operation device 55 is operated while the ECU 90 executes the autonomous moving control, the ECU 90 determines that the autonomous moving control is not requested to be executed. That is, the ECU 90 determines that an execution of the autonomous moving control is requested to be stopped.

<Second Driving Assistance Operator>

The second driving assistance operation device 56 or an economy driving assistance operation device is a device such as a button or a switch which is operated by the driver. The driver can request the vehicle moving control apparatus 10 to execute a second autonomous moving control described later or stop executing the second autonomous moving control by operating the second driving assistance operation device 56.

The second driving assistance operation device 56 is electrically connected to the ECU 90. When the second driving assistance operation device 56 is operated while the ECU 90 does not execute the second autonomous moving control, the ECU 90 determines that the second autonomous moving control is requested to be executed. Thereafter, the ECU 90 keeps determining that the second autonomous moving control is requested to be executed as far as the second driving assistance operation device 56 is not operated. On the other hand, when the second driving assistance operation device 56 is operated while the ECU 90 executes the second autonomous moving control, the ECU 90 determines that the second autonomous moving control is not requested to be executed. That is, the ECU 90 determines that an execution of the second autonomous moving control is requested to be stopped.

<Vehicle Moving Speed Detection Device>

The vehicle moving speed detection device 57 is a device which detects a moving speed of the own vehicle 100. The vehicle moving speed detection device 57 may include vehicle wheel rotation speed sensors provided on vehicle wheels of the own vehicle 100, respectively. The vehicle moving speed detection device 57 is electrically connected to the ECU 90. The ECU 90 acquires the moving speed of the own vehicle 100 as an own vehicle moving speed V by the vehicle moving speed detection device 57.

<Surrounding Information Detection Apparatus>

The surrounding information detection apparatus 60 is an apparatus which acquires information on a situation around the own vehicle 100. In this embodiment, the surrounding information detection apparatus 60 includes electromagnetic wave sensors 61 and image sensors 62.

<Electromagnetic Wave Sensors>

The electromagnetic wave sensor 61 is a sensor which acquires object data, i.e., data on objects around the own vehicle 100. The electromagnetic wave sensor 61 may be a radio wave sensor such as a radar sensor such as a millimeter wave radar, a sound wave sensor such as an ultrasonic wave sensor such as a clearance sonar, and an optical sensor such as a laser radar such as a LiDAR. The electromagnetic wave sensor 61 transmits electromagnetic waves and receives reflected waves, i.e., the electromagnetic waves reflected by the objects. The object data is information on the transmitted electromagnetic waves and the reflected waves. The electromagnetic wave sensors 61 are electrically connected to the ECU 90. The ECU 90 acquires the object data as surrounding detection information IS from the electromagnetic wave sensors 61.

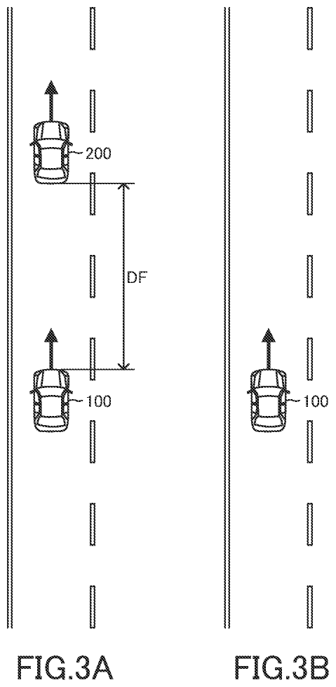

For example, as shown in FIG. 3A, when there is a preceding vehicle 200 which is a vehicle around the own vehicle 100, the ECU 90 detects the preceding vehicle 200, based on the object data as the surrounding detection information IS. In addition, the ECU 90 acquires a preceding inter-vehicle distance DF, i.e., a distance between the preceding vehicle 200 and the own vehicle 100.

The preceding vehicle 200 is a vehicle which moves ahead of the own vehicle 100 in an own vehicle moving lane within a predetermine distance from the own vehicle 100. The own vehicle moving lane is a traffic lane in which the own vehicle 100 moves. The vehicle moving control apparatus 10 acquires a left lane marking on the left side of the own vehicle 100 and a right lane marking on the right side of the own vehicle 100 and detects the own vehicle moving lane, based on the acquired left lane marking and the acquired right lane marking.

<Image Sensors>

The image sensor 62 is a sensor which captures images of a view around the own vehicle 100 to acquire image data. The image sensor 62 may be a camera sensor. The image sensors 62 are electrically connected to the ECU 90. The ECU 90 acquires the image data as the surrounding detection information IS from the image sensors 62.

The ECU 90 recognizes the situation ahead of the own vehicle 100, based on the image data as the surrounding detection information IS.

<Road Information Acquisition Device>

A road information acquisition device 70 is a device which acquires information on a road on which the own vehicle 100 moves. In particular, in this embodiment, the road information acquisition device 70 is a device which receives GPS signals and acquires a present position of the own vehicle 100, based on the received GPS signals and acquires map information on an area around the own vehicle 100. The map information on the area around the own vehicle 100 includes road information, i.e., information on the road on which the own vehicle 100 moves.

In this embodiment, the road information acquisition device 70 includes a GPS receiver 71 and a map database 72.

The GPS receiver 71 receives the GPS signals. The GPS receiver 71 is electrically connected to the ECU 90. The ECU 90 acquires the present position of the own vehicle 100 as the surrounding detection information IS, based on the GPS signals received by the GPS receiver 71.

The map database 72 is a device which stores the map information. The map database 72 is electrically connected to the ECU 90. The ECU 90 acquires the map information on the area around the own vehicle 100 as the surrounding detection information IS from the map database 72, based on the present position of the own vehicle 100. The ECU 90 determines whether there is a downward slope in a moving direction of the own vehicle 100, i.e., on the road on which the own vehicle 100 predictively moves, based on the map information.

It should be noted that the surrounding information detection apparatus 60 may include a device which receives information on the road wirelessly transmitted from equipment provided at the side of the road. In this case, the surrounding information detection apparatus 60 is configured to acquire the information transmitted from the equipment provided at the side of the road as the surrounding detection information IS. In this case, the ECU 90 determines whether there is the downward slope in the moving direction of the own vehicle 100, i.e., on the road on which the own vehicle 100 predictively moves, based on the acquired surrounding detection information IS.

<Operations of Vehicle Moving Control Apparatus>

Next, operations of the vehicle moving control apparatus 10 will be described. The vehicle moving control apparatus 10 is configured to execute the autonomous moving control to cause the own vehicle 100 to move by autonomously accelerating or decelerating the own vehicle 100.

In this embodiment, the autonomous moving control includes a first autonomous moving control and a second autonomous moving control. The first autonomous moving control includes a first moving speed control (or a first constant speed moving control) and a first inter-vehicle distance control (or a first following moving control). The second autonomous moving control includes a second moving speed control (or an economy moving speed control) and a second inter-vehicle distance control (or an economy following moving control).

<First Moving Speed Control>

The first moving speed control is the autonomous moving control to autonomously control an acceleration and a deceleration of the own vehicle 100 so as to maintain the own vehicle moving speed V at a target speed Vtgt. The first moving speed control is executed when there is no preceding vehicle as shown in FIG. 3B while a driving assistance condition is satisfied, and a second driving assistance condition is not satisfied.

The driving assistance condition is a condition that the autonomous moving control is requested to be executed. The second driving assistance condition is a condition that the second autonomous moving control is requested to be executed.

The vehicle moving control apparatus 10 accelerates the own vehicle 100 when the own vehicle moving speed V becomes smaller than the target speed Vtgt while the first moving speed control is executed. On the other hand, the vehicle moving control apparatus 10 decelerates the own vehicle 100 when the own vehicle moving speed V becomes greater than the target speed Vtgt while the first moving speed control is executed.

That is, the vehicle moving control apparatus 10 executes an acceleration control to accelerate the own vehicle 100 when an acceleration condition that the own vehicle moving speed V becomes smaller than the target speed Vtgt, becomes satisfied while the first moving speed control is executed. On the other hand, the vehicle moving control apparatus 10 executes a deceleration control to decelerate the own vehicle 100 when a deceleration condition that the own vehicle moving speed V becomes greater than the target speed Vtgt, becomes satisfied while the first moving speed control is executed.

It should be noted that the vehicle moving control apparatus 10 sets a target moving speed of the own vehicle 100 set by the driver as the target speed Vtgt. The driver of the own vehicle 100 can set the target moving speed of the own vehicle 100 by operating a moving speed setting operation device such as a moving speed setting button. Alternatively, the vehicle moving control apparatus 10 sets as the target speed Vtgt, the own vehicle moving speed V of a point of time when the driving assistance condition becomes satisfied in response to the driving assistance operation device 55 being operated.

<First Inter-Vehicle Distance Control>

The first inter-vehicle distance control is the autonomous moving control to autonomously control the acceleration and the deceleration of the own vehicle 100 so as to maintain the preceding inter-vehicle distance DF at a target distance Dtgt. The first inter-vehicle distance control is executed when there is the preceding vehicle 200 as shown in FIG. 3A while the driving assistance condition is satisfied, and the second driving assistance condition is not satisfied.

The vehicle moving control apparatus 10 accelerates the own vehicle 100 when the preceding inter-vehicle distance DF becomes greater than the target distance Dtgt while the first inter-vehicle distance control is executed. On the other hand, the vehicle moving control apparatus 10 decelerates the own vehicle 100 when the preceding inter-vehicle distance DF becomes smaller than the target distance Dtgt while the first inter-vehicle distance control is executed.

That is, the vehicle moving control apparatus 10 executes the acceleration control to accelerate the own vehicle 100 when an acceleration condition that the preceding inter-vehicle distance DF becomes greater than the target distance Dtgt, becomes satisfied while the first inter-vehicle distance control is executed. On the other hand, the vehicle moving control apparatus 10 executes the deceleration control to decelerate the own vehicle 100 when a deceleration condition that the preceding inter-vehicle distance DF becomes smaller than the target distance Dtgt, becomes satisfied while the first inter-vehicle distance control is executed.

In this embodiment, the vehicle moving control apparatus 10 sets the target distance Dtgt, based on the preceding inter-vehicle distance DF set by the driver of the own vehicle 100. In this regard, the vehicle moving control apparatus 10 may set the preceding inter-vehicle distance DF set by the driver as the target distance Dtgt.

In particular, the vehicle moving control apparatus 10 (i) calculates an inter-vehicle time Td, based on the preceding inter-vehicle distance DF set by the driver and (ii) sets the calculated inter-vehicle time Td as a target inter-vehicle time Tdtgt. The inter-vehicle time Td is a time taken for the own vehicle 100 to move the preceding inter-vehicle distance DF. In particular, the inter-vehicle time Td is a value acquired by dividing the preceding inter-vehicle distance DF by the own vehicle moving speed V (Td=DF/V). Therefore, the target inter-vehicle time Tdtgt is a target value of the time taken for the own vehicle 100 to move the preceding inter-vehicle distance DF. In this embodiment, the target inter-vehicle time Tdtgt is a value acquired by dividing the target preceding inter-vehicle distance DFtgt (i.e., the preceding inter-vehicle distance DF set by the driver of the own vehicle 100) by the own vehicle moving speed V (Tdtgt=DFtgt/V). It should be noted that the inter-vehicle time Td increases as the preceding inter-vehicle distance DF increases.

The vehicle moving control apparatus 10 sets as the target distance Dtgt, a value acquired by multiplying the set target inter-vehicle time Tdtgt by the current own vehicle moving speed V.

It should be noted that the driver can set the preceding inter-vehicle distance DF by operating an inter-vehicle distance setting operation device such as an inter-vehicle distance setting button. In this embodiment, the driver can optionally set as the preceding inter-vehicle distance DF, one of the long preceding inter-vehicle distance, the middle preceding inter-vehicle distance, and the short preceding inter-vehicle distance.

Further, the vehicle moving control apparatus 10 may be configured to set as the target inter-vehicle time Tdtgt, the inter-vehicle time Td associated with the preceding inter-vehicle distance DF of a point of time when the driving assistance condition becomes satisfied in response to the driving assistance operation device 55 being operated.

<Second Moving Speed Control>

The second moving speed control is the autonomous moving control to autonomously control the acceleration and the deceleration of the own vehicle 100 so as to maintain the own vehicle moving speed V within a target speed range RVtgt. The second moving speed control is executed when there is no preceding vehicle as shown in FIG. 3B while the driving assistance condition is satisfied, and the second driving assistance condition is satisfied.

The target speed range RVtgt is a range including the target speed Vtgt. In this embodiment, the target speed range RVtgt has (i) an upper limit speed Vupper corresponding to a speed greater than the target speed Vtgt by a predetermined value or an upper limit speed setting value ΔVupper, and (ii) a lower limit speed Vlower corresponding to a speed smaller than the target speed Vtgt by a predetermined value or a lower limit speed setting value ΔVlower. The upper limit speed setting value ΔVupper and the lower limit speed setting value ΔVlower may be equal to or different from each other.

The vehicle moving control apparatus 10 accelerates the own vehicle 100 when the own vehicle moving speed V becomes smaller than the lower limit speed Vlower while the second moving speed control is executed. On the other hand, the vehicle moving control apparatus 10 decelerates the own vehicle 100 when the own vehicle moving speed V becomes greater than the upper limit speed Vupper while the second moving speed control is executed.

That is, the vehicle moving control apparatus 10 executes the acceleration control to accelerate the own vehicle 100 when an acceleration condition that the own vehicle moving speed V becomes smaller than the lower limit speed Vlower, becomes satisfied while the second moving speed control is executed. On the other hand, the vehicle moving control apparatus 10 executes the deceleration control to decelerate the own vehicle 100 when a deceleration condition that the own vehicle moving speed V becomes greater than the upper limit speed Vupper, becomes satisfied while the second moving speed control is executed.

In particular, in this embodiment, the vehicle moving control apparatus 10 executes an optimum acceleration control as the acceleration control while the second moving speed control is executed. Further, the vehicle moving control apparatus 10 executes a coasting control as the deceleration control while the second moving speed control is executed.

The optimum acceleration control is a control to accelerate the own vehicle 100 by controlling an activation of the power apparatus 20 (in this embodiment, the internal combustion engine 21 and the second motor generator 222) so as to maintain an energy efficiency of the power apparatus 20 at a predetermined efficiency or more. In this embodiment, the optimum acceleration control is a control to accelerate the own vehicle 100 by controlling the activation of the power apparatus 20 so as to maintain the energy efficiency of the power apparatus 20 at the maximum energy efficiency or at the energy efficiency close to the maximum energy efficiency.

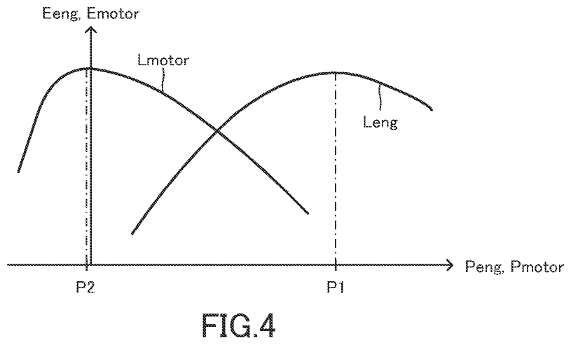

For example, when a relationship between an engine power Peng and an energy efficiency Eeng of the internal combustion engine 21 is one shown by a line Leng in FIG. 4, and a relationship between a motor power Pmotor (i.e., the power output from the second motor generator 222) and an energy efficiency Emotor of the second motor generator 222 is one shown by a line Lmotor in FIG. 4, the vehicle moving control apparatus 10 activates the internal combustion engine 21 at an optimum activation point, i.e., at an activation point to maintain the energy efficiency Eeng of the internal combustion engine 21 at the maximum energy efficiency. It should be noted that the activation point is a point defined by a rotation speed of the internal combustion engine 21 and a load of the internal combustion engine 21.

When the internal combustion engine 21 is activated at the optimum activation point, the energy efficiency Eeng is the greatest value or the maximum efficiency, and the engine power Peng of an example shown in FIG. 4 is an optimum engine power P1, i.e., a value corresponding to the maximum efficiency. It should be noted that a reference symbol P2 shown in FIG. 4 is a value of the motor power when the energy efficiency Emotor of the second motor generator 222 is the greatest efficiency.

The coasting control is a control to control the activation of the power apparatus 20 and an activation of the power distribution device 110 so as to cause the own vehicle 100 to coast. While the coasting control is executed, the own vehicle 100 is decelerated mainly by an air resistance and a road surface resistance. In other words, the coasting control is a control to control the activations of the power apparatus 20 and the power distribution device 110 such that the own vehicle 100 is decelerated mainly by the air resistance and the road surface resistance.

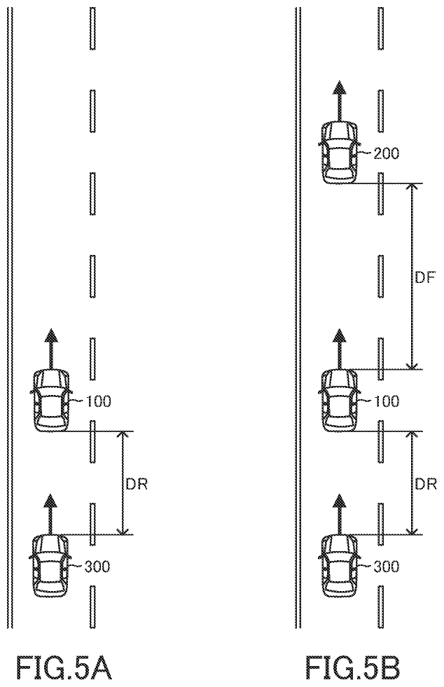

In this regard, in a situation that there is a following vehicle 300 which is one of vehicles around the own vehicle 100 as shown in FIG. 5A, the vehicle moving control apparatus 10 may be configured to execute the optimum acceleration control to accelerate the own vehicle 100 when a following inter-vehicle distance DR (i.e., a distance between the own vehicle 100 and the following vehicle 300) becomes equal to or smaller than a predetermined distance or a predetermined following inter-vehicle distance DRth even when the own vehicle moving speed V is greater than the lower limit speed Vlower while the second moving speed control is executed. In this case, the vehicle moving control apparatus 10 continues executing the optimum acceleration control until the own vehicle moving speed V reaches the upper limit speed Vupper even when the following inter-vehicle distance DR becomes greater than the predetermined following inter-vehicle distance DRth after the vehicle moving control apparatus 10 starts to execute the optimum acceleration control.

Further, in the situation that there is the following vehicle 300, the vehicle moving control apparatus 10 may be configured to determine a timing of starting to execute the optimum acceleration control so as not to cause the own vehicle 100 to be too close to the following vehicle 300 in consideration of a difference between the own vehicle moving speed V and a moving speed of the following vehicle 300 while the second moving speed control is executed.

It should be noted that the following vehicle 300 is a vehicle which moves behind the own vehicle 100 in the own vehicle moving lane within a predetermined distance from the own vehicle 100. The vehicle moving control apparatus 10 detects the following vehicle 300 and acquires the following inter-vehicle distance DR, based on the surrounding detection information IS.

<Second Inter-Vehicle Distance Control>

The second inter-vehicle distance control is the autonomous moving control to autonomously control the acceleration and the deceleration of the own vehicle 100 so as to maintain the preceding inter-vehicle distance DF within a target distance range RDtgt. The second inter-vehicle distance control is executed when there is the preceding vehicle 200 as shown in FIG. 3A while the driving assistance condition is satisfied, and the second driving assistance condition is satisfied.

The target distance range RDtgt is a range including the target distance Dtgt. In this embodiment, the target distance range RDtgt has (i) an upper limit distance Dupper corresponding to a distance greater than the target distance Dtgt by a predetermined value or an upper limit distance setting value ΔDupper, and (ii) a lower limit distance Dlower corresponding to a distance smaller than the target distance Dtgt by a predetermined value or a lower limit distance setting value ΔDlower. In other words, the target distance range RDtgt has (i) an upper limit value corresponding to a value greater than the target distance Dtgt which corresponds to a value acquired by multiplying a target value of time taken for the own vehicle 100 to move the preceding inter-vehicle distance DF by a first value or the upper limit distance setting value ΔDupper, and (ii) a lower value corresponding to a value smaller than the target distance Dtgt by a second value or the lower limit distance setting value ΔDlower. It should be noted that the upper limit distance setting value ΔDupper and the lower limit distance setting value ΔDlower may be equal to or different from each other.

The vehicle moving control apparatus 10 accelerates the own vehicle 100 when the preceding inter-vehicle distance DF becomes greater than the upper limit distance Dupper while the second inter-vehicle distance control is executed. The vehicle moving control apparatus 10 decelerates the own vehicle 100 when the preceding inter-vehicle distance DF becomes smaller than the lower limit distance Dlower while the second inter-vehicle distance control is executed.

That is, the vehicle moving control apparatus 10 executes the acceleration control to accelerate the own vehicle 100 when an acceleration condition that the preceding inter-vehicle distance DF becomes greater than the upper limit distance Dupper, becomes satisfied while the second inter-vehicle distance control is executed. The vehicle moving control apparatus 10 executes the deceleration control to decelerate the own vehicle 100 when a deceleration condition that the preceding inter-vehicle distance DF becomes smaller than the lower limit distance Dlower, becomes satisfied while the second inter-vehicle distance control is executed.

In particular, in this embodiment, the vehicle moving control apparatus 10 executes the optimum acceleration control as the acceleration control while the second inter-vehicle distance control is executed. Further, the vehicle moving control apparatus 10 executes the coasting control as the deceleration control while the second inter-vehicle distance control is executed.

In this regard, in a situation that there is the following vehicle 300 as shown in FIG. 5B, the vehicle moving control apparatus 10 may be configured to execute the optimum acceleration control to accelerate the own vehicle 100 when the following inter-vehicle distance DR becomes equal to or smaller than the predetermined following inter-vehicle distance DRth even when the preceding inter-vehicle distance DF is smaller than the upper limit distance Dupper while the second inter-vehicle distance control is executed. In this case, the vehicle moving control apparatus 10 continues executing the optimum acceleration control until the preceding inter-vehicle distance DF reaches the lower limit distance Dlower even when the following inter-vehicle distance DR becomes greater than the predetermined following inter-vehicle distance DRth after the vehicle moving control apparatus 10 starts to execute the optimum acceleration control.

Further, in the situation that there is the following vehicle 300, the vehicle moving control apparatus 10 may be configured to determine the timing of starting to execute the optimum acceleration control so as not to cause the own vehicle 100 to be too close to the following vehicle 300 in consideration of the difference between the own vehicle moving speed V and the moving speed of the following vehicle 300 while the second inter-vehicle distance control is executed.

<Battery Stored Electric Power Amount>

The own vehicle 100 is installed with electric components 41 such as an air conditioner and headlights, and a multi-media such as a car navigation system. The electric components 41 are electric loads 40 and are activated by the electricity. The electricity for activating the electric components 41 is supplied from the battery 231 to the electric components 41. Thus, when the electric components 41 are activated, the battery electricity (i.e., the electricity stored in the battery 231) is consumed. Therefore, when the battery 231 is not charged while the electricity stored in the battery 231 is consumed, the battery-stored electricity amount SOC (i.e., the stored electricity amount of the battery 231) becomes extremely small.

Accordingly, the vehicle moving control apparatus 10 is configured to input a part of the engine power to the first motor generator 221 to generate the electricity and store the generated electricity into the battery 231 in order to maintain the battery-stored electricity amount SOC at a predetermined value or a normal charge threshold SOC_N or more while the normal moving control or the first autonomous moving control is executed.

In this regard, the normal charge threshold SOC_N may have a control hysteresis.

Further, the vehicle moving control apparatus 10 executes a regeneration charge coasting control as the coasting control when the deceleration condition is satisfied, and the battery-stored electricity amount SOC is equal to or smaller than a predetermined value or a first deceleration charge threshold SOC_D1 while the second autonomous moving control is executed.

The regeneration charge coasting control is a control to cause the own vehicle 100 to coast and store the electricity into the battery 231 by (i) stopping the activation of the internal combustion engine 21 and an activation of the second motor generator 222 as the power sources, (ii) inputting an own vehicle moving energy (i.e., the moving energy of the own vehicle 100) to the second motor generator 222 to perform a regeneration of the own vehicle moving energy by the second motor generator 222 to generate the electricity, and (iii) storing the generated electricity into the battery 231.

That is, the regeneration charge coasting control is a control to cause the own vehicle 100 to coast and store the electricity into the battery 231 by (i) stopping the activation of the power apparatus 20, (ii) inputting the own vehicle moving energy to the second motor generator 222 to perform the regeneration of the own vehicle moving energy by the second motor generator 222 to generate the electricity, and (iii) storing the generated electricity into the battery 231.

In other words, the regeneration charge coasting control is a control to cause the own vehicle 100 to coast and store the electricity into the electricity storage device 23 by (i) stopping activations of the power sources, (ii) performing the regeneration of the own vehicle moving energy by the electricity generation device 22 to generate the electricity, and (iii) storing the generated electricity into the electricity storage device 23.

It should be noted that the first deceleration charge threshold SOC_D1 may be an optional value. In this embodiment, the first deceleration charge threshold SOC_D1 is a value smaller than the normal charge threshold SOC_N. Further, the first deceleration charge threshold SOC_D1 may have a control hysteresis.

Thereby, when (i) the second autonomous moving control is executed, (ii) the deceleration condition is satisfied, and (iii) the battery-stored electricity amount SOC becomes small (in particular, the battery-stored electricity amount SOC becomes equal to or smaller than the first deceleration charge threshold SOC_D1), the activation of the power apparatus 20 is stopped, the electricity is generated by the regeneration of the own vehicle moving energy, and the generated electricity is stored into the battery 231. Thus, the battery-stored electricity amount SOC can be prevented from becoming excessively small even when the activation of the power apparatus 20 is stopped, and the own vehicle 100 is caused to coast.

Furthermore, the electricity is generated by the regeneration of the own vehicle moving energy when the deceleration condition is satisfied while the second autonomous moving control is executed. Thus, the own vehicle decelerates. Therefore, the deceleration of the own vehicle 100 is not limited even when the battery 231 is being charged.

On the other hand, the vehicle moving control apparatus 10 executes a normal coasting control as the coasting control when the deceleration condition is satisfied, and the battery-stored electricity amount SOC is greater than the first deceleration charge threshold SOC_D1 while the second autonomous moving control is executed.

The normal coasting control is a control to cause the own vehicle 100 to coast by stopping the activation of the power apparatus 20 (in particular, the activations of the internal combustion engine 21 and the second motor generator 222 as the power sources) without performing the regeneration of the own vehicle moving energy by the second motor generator 222.

In other words, the normal coasting control is a control to cause the own vehicle 100 to coast by stopping the activations of the power sources without performing the regeneration of the own vehicle moving energy.

Further, while the generation charge coasting control is executed, the battery electricity (i.e., the electricity stored in the battery 231) continues being consumed by the electric loads 40. In this case, even when the generation charge coasting control is executed to generate the electricity by the regeneration of the own vehicle moving energy, and the generated electricity is being stored into the battery 231, the battery-stored electricity amount SOC may decrease and become too small.

Accordingly, the vehicle moving control apparatus 10 executes a power charge moving control when the deceleration condition is satisfied, and the battery-stored electricity amount SOC is equal to or smaller than a predetermined value or a second deceleration charge threshold SOC_D2 while the second autonomous moving control is executed. The second deceleration charge threshold SOC_D2 is smaller than the first deceleration charge threshold SOC_D1.

The power charge moving control is a control to cause the own vehicle 100 to move and store the electricity into the battery 231 by (i) activating the internal combustion engine 21 to generate the power, (ii) inputting the generated power to the first motor generator 221 to generate the electricity, and (iii) storing the generated electricity into the battery 231.

In other words, the power charge moving control is a control to cause the own vehicle 100 to move and store the electricity into the electricity storage device 23 by (i) activating the power source to generate the power, (ii) activating the electricity generation device 22 by the generated power to generate the electricity, and (iii) storing the generated electricity into the electricity storage device 23.

For example, the power charge moving control is a power charge coasting control to cause the own vehicle 100 to coast and store the electricity into the battery 231 by (i) stopping the activation of the second motor generator 222 as the power source (i.e., stopping the generation of the power by the second motor generator 222), (ii) activating the internal combustion engine 21 to generate the power, (iii) inputting all of the generated power to the first motor generator 221 to generate the electricity without inputting the generated power to the driving shaft 120, and (iv) storing the generated electricity into the battery 231.

In other words, the power charge moving control is the power charge coasting control to cause the own vehicle 100 to coast and store the electricity into the electricity storage device 23 by (i) activating the power apparatus 20 to generate the power, (ii) inputting all of the power generated by the power apparatus 20 to the electricity generation device 22 to generate the electricity without inputting the generated power to the driving shaft 120, and (iii) storing the generated electricity into the electricity storage device 23.

In this regard, the power charge moving control may be a control to execute the first autonomous moving control to cause the own vehicle 100 to move and store the electricity into the battery 231 by (i) stopping the activation of the second motor generator 222 as the power source (i.e., stopping the generation of the power by the second motor generator 222), (ii) activating the internal combustion engine 21 to generate the power, (iii) inputting a part of the generated power to the first motor generator 221 to generate the electricity, (iv) storing the generated electricity into the battery 231, and (iv) inputting the remaining generated power to the driving shaft 120. In this case, when the second moving speed control is executed before the power charge moving control starts to be executed, the first moving speed control is executed. On the other hand, when the second inter-vehicle distance control is executed before the power charge moving control starts to be executed, the first inter-vehicle distance control is executed.

In other words, the power charge moving control may be a control to cause the own vehicle 100 to move and store the electricity into the electricity storage device 23 by (i) activating the power apparatus 20 to generate the power, (ii) inputting a part of the generated power to the electricity generation device 22 to generate the electricity, (iii) storing the generated electricity into the electricity storage device 23, and (iv) moving the own vehicle 100 by the remaining generated power.

It should be noted that the vehicle moving control apparatus 10 restarts to execute the regeneration charge coasting control when the battery-stored electricity amount SOC becomes greater than the second deceleration charge threshold SOC_D2 while the power charge moving control is executed. That is, the vehicle moving control apparatus 10 executes the regeneration charge coasting control when the deceleration condition is satisfied, and the battery-stored electricity amount SOC is equal to or smaller than the first deceleration charge threshold SOC_D1 and greater than the second deceleration charge threshold SOC_D2.

It should be noted that the second deceleration charge threshold SOC_D2 is an optional value smaller than the first deceleration charge threshold SOC_D1. Further, the second deceleration charge threshold SOC_D2 may have a control hysteresis.

As described above, the vehicle moving control apparatus 10 executes the power charge moving control to activate the power apparatus 20 to generate the power, activate the first motor generator 221 by the generated power to generate the electricity, and store the generated electricity into the battery 231 when the battery-stored electricity amount SOC becomes too small (i.e., the battery-stored electricity amount SOC becomes equal to or smaller than the second deceleration charge threshold SOC_D2) while the regeneration charge coasting control is executed. Thereby, the battery-stored electricity amount SOC can be prevented from becoming excessively small.

Further, as described above, the battery electricity (i.e., the electricity stored in the battery 231) may continue being consumed by the electric loads 40 while the regeneration charge coasting control is executed. In this case, the battery-stored electricity amount SOC can be increased to the first deceleration charge threshold SOC_D1 early by increasing the amount of the electricity generated by the regeneration charge coasting control. In this case, however, the deceleration rate of the own vehicle 100 increases, and the driver may feel a discomfort. On the other hand, the battery-stored electricity amount SOC can be prevented from becoming excessively small while the activation of the power apparatus 20 is stopped by (i) generating the amount of the electricity meeting the amount of the electricity consumed from the battery 231 by the electric loads 40 and (ii) storing the generated electricity into the battery 231.

Accordingly, the vehicle moving control apparatus 10 performs the regeneration of the own vehicle moving energy by the second motor generator 222 to generate the amount of the electricity depending on the amount of the electricity consumed from the battery 231 by the electric loads 40 while the regeneration charge coasting control is executed.

Thereby, the amount of the electricity is generated, depending on the amount of the electricity consumed from the battery 231 by the electric loads 40 while the regeneration charge coasting control is executed. Therefore, the battery-stored electricity amount SOC can be prevented from becoming excessively small without generating the excessive deceleration rate of the own vehicle 100 leading to a discomfort of the driver.

Alternatively, the vehicle moving control apparatus 10 may be configured to limit the amount of the electricity generated by performing the regeneration of the own vehicle moving energy by the second motor generator 222 so as to maintain the deceleration rate of the own vehicle 100 at a predetermined deceleration rate or less while the regeneration charge coasting control is executed.

As described above, the battery-stored electricity amount SOC can be increased to the first deceleration charge threshold SOC_D1 early by increasing the amount of the electricity generated by the regeneration charge coasting control. In this case, however, the deceleration rate of the own vehicle 100 increases, and the driver may feel a discomfort.

With the vehicle moving control apparatus 10, the amount of the electricity generated by the regeneration of the own vehicle moving energy is limited so as to maintain the deceleration rate of the own vehicle 100 at the predetermined deceleration rate or less while the regeneration charge coasting control is executed. Therefore, the battery-stored electricity amount SOC can be prevented from becoming excessively small without generating the excessive deceleration rate of the own vehicle 100 leading to a discomfort of the driver.

Further, the vehicle moving control apparatus 10 executes a power charge optimum acceleration control as the acceleration control when the acceleration condition is satisfied, and the battery-stored electricity amount SOC is equal to or smaller than a predetermined value or an acceleration charge threshold SOC_A while the second autonomous moving control is executed.

The power charge optimum acceleration control is the acceleration control to accelerate the own vehicle 100 and store the electricity into the battery 231 by (i) activating the internal combustion engine 21 at the maximum efficiency to generate the power, (ii) inputting a part of the generated power to the first motor generator 221 to generate the electricity, (iii) storing the generated electricity into the battery 231, and (iv) inputting the remaining generated power to the driving shaft 120 as a driving power (i.e., the power for driving the own vehicle 100) to accelerate the own vehicle 100.

In other words, the power charge optimum acceleration control is the acceleration control to accelerate the own vehicle 100 and store the electricity into the electricity storage device 23 by (i) activating the internal combustion engine 21 to generate the power, (ii) activating the electricity generation device 22 by a part of the generated power to generate the electricity, (iii) storing the generated electricity into the electricity storage device 23, and (iv) accelerating the own vehicle 100 by the remaining generated power.

Further, in other words, the power charge optimum acceleration control is the acceleration control to accelerate the own vehicle 100 and store the electricity into the electricity storage device 23 by (i) activating the power source to generate the power, (ii) activating the electricity generation device 22 by a part of the generated power to generate the electricity, (iii) storing the generated electricity into the electricity storage device 23, and (iv) accelerating the own vehicle 100 by the remaining generated power.

If the enough amount of the electricity is stored into the battery 231 while the acceleration control is executed, the battery-stored electricity amount can be prevented from becoming excessively small while the coasting control is executed

With the vehicle moving control apparatus 10, the acceleration control is executed by executing the power charge acceleration control to activate the internal combustion engine 21 to generate the power, generate the electricity by a part of the generated power, store the generated electricity into the battery 231, and accelerate the own vehicle 100 by the remaining generated power when the acceleration condition is satisfied, and the battery-stored electricity amount SOC becomes small (i.e., the battery-stored electricity amount SOC becomes equal to or smaller than the acceleration charge threshold SOC_A). Thus, the enough amount of the electricity is stored into the battery 231 while the acceleration control is executed. Therefore, the battery-stored electricity amount can be prevented from becoming excessively small while the coasting control is executed.

It should be noted that the acceleration charge threshold SOC_A is an optional value. In this embodiment, the acceleration charge threshold SOC_A is greater than the normal charge threshold SOC_N. Further, the acceleration charge threshold SOC_A may have a control hysteresis.

The vehicle moving control apparatus 10 calculates and acquires a battery electricity decrease amount ΔSOC and stores the acquired battery electricity decrease amount ΔSOC while the normal coasting control is executed. The battery electricity decrease amount ΔSOC is a decrease amount of the battery-stored electricity amount SOC decreased by consuming the electricity in the battery 231 by the electric loads 40 while the normal coasting control is executed.

The vehicle moving control apparatus 10 inputs a part of the engine power to the first motor generator 221 so as to generate at least an amount of the electricity corresponding to the battery electricity decrease amount ΔSOC by the first motor generator 221 while the power charge optimum acceleration control is executed.

Further, in this embodiment, while the power charge optimum acceleration control is executed, the vehicle moving control apparatus 10 (i) inputs a part of the engine power to the first motor generator 221 to generate the amount of the electricity corresponding to the battery electricity decrease amount ΔSOC and the amount of the electricity consumed by the electric loads 40 while the power charge optimum acceleration control is executed, and (ii) inputs the remaining engine power to the driving shaft 120 as the driving power (i.e., the power for driving the own vehicle 100).

In particular, the vehicle moving control apparatus 10 inputs the engine power Pm calculated by a following formula 1 to the first motor generator 221 and inputs the engine power Pd calculated by a following formula 2 to the driving shaft 120.

Pm=Pac+Pbc (1)

Pd=Pe*−Pm (2)

Pbc=f(SOC)+f(Es/T) (3)

In the formulae 1 and 2, “Pac” is the engine power necessary to generate the amount of the electricity corresponding to the amount of the electricity consumed by the electric loads 40 while the power charge optimum acceleration control is executed, and “Pbc” is the engine power necessary to generate the amount of the electricity calculated, based on the battery electricity decrease amount ΔSOC. The engine power Pbc is calculated by a formula 3 above.

In the formula 3, “f(SOC)” is the engine power necessary to generate the amount of the electricity per unit time to be stored into the battery 231, based on the battery-stored electricity amount SOC. A value f(SCO) increases as the battery-stored electricity amount SOC decreases.

Further, in the formula 3, “Es” is the battery electricity decrease amount ΔSOC, i.e., the decrease amount of the battery-stored electricity amount SOC decreased by consuming the electricity in the battery 231 by the electric loads 40 while the normal coasting control is executed, “T” is a predicted execution time of the power charge optimum acceleration control, i.e., a time for which the power charge optimum acceleration control is predictively executed, “f(Es/T)” is the engine power necessary to generate the amount of the electricity per unit time necessary to charge the battery 231, based on the battery electricity decrease amount ΔSOC. The value f(Es/T) increases as the battery electricity decrease amount ΔSOC increases. In addition, the value f(Es/T) increases as the predicted execution time T decreases.

Further, in the formula 2, “Pe*” is an optimum power, i.e., the power input from the internal combustion engine 21 to the power distribution device 110 when the internal combustion engine 21 is activated at the maximum efficiency.

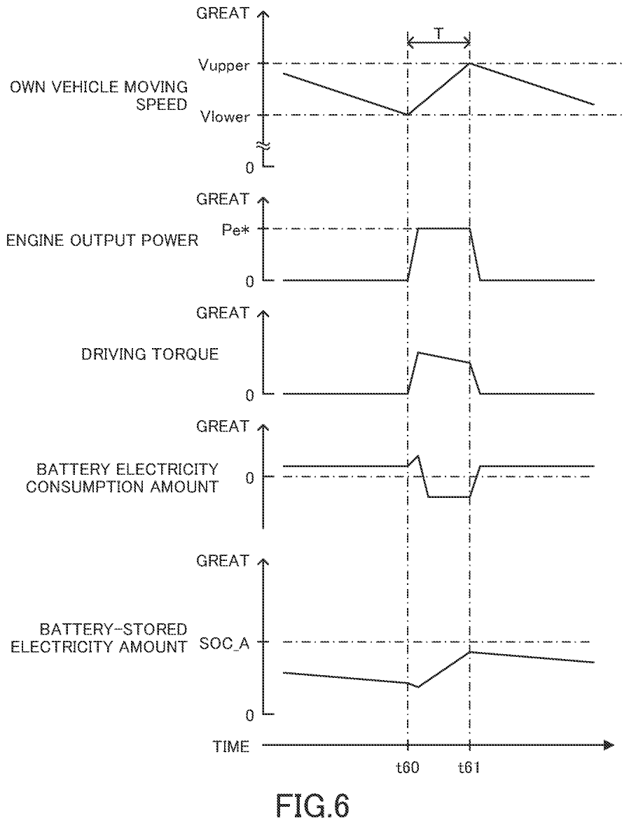

With the controls described above, the battery-stored electricity amount SOC may change while the first moving speed control is executed as shown in FIG. 6. That is, in an example shown in FIG. 6, the normal coasting control is executed until a time t60. Therefore, the engine power is zero, and a driving torque (i.e., a torque input to the driving shaft 120 by the engine power) is also zero. Therefore, the own vehicle moving speed V gradually decreases. In addition, the battery electricity (i.e., the electricity stored in the battery 231) is continuously consumed by the electric loads 40 until the time t60. A battery electricity consumption amount SOC_C (i.e., the amount of the battery electricity consumed by the electric loads 40) is greater than zero. Therefore, the battery-stored electricity amount SOC gradually decreases.

When the own vehicle moving speed V reaches the lower limit speed Vlower at the time t60, the optimum acceleration control starts to be executed. At this time, the battery-stored electricity amount SOC is smaller than the acceleration charge threshold SOC_A. Thus, the power charge optimum acceleration control starts to be executed as the optimum acceleration control. Therefore, at the time t60, the internal combustion engine 21 starts to be activated. At this time, the electricity is supplied from the battery 231 to the first motor generator 221. Thereby, the internal combustion engine 21 is activated by the power generated by the first motor generator 221. Therefore, at the time t60, the battery electricity consumption amount SOC_C starts to increase. Thus, the battery-stored electricity amount SOC starts to decrease. When the internal combustion engine 21 is activated, a supply of the electricity from the battery 231 to the first motor generator 221 is stopped. Therefore, the battery electricity consumption amount SOC_C starts to decrease.

After the internal combustion engine 21 starts to be activated at the time t60, the engine output power (i.e., the power output from the internal combustion engine 21) increases to the optimum power Pe* and as a result, the driving torque increases. Thereby, the own vehicle moving speed V gradually increases. It should be noted that the driving torque is gradually decreased as the own vehicle moving speed V increases.

In addition, after the internal combustion engine 21 starts to be activated, a part of the engine output power is input to the first motor generator 221 to generate the electricity, and the generated electricity is stored into the battery 231. Therefore, the battery electricity consumption amount SOC_C turns to a negative value, and the battery-stored electricity amount SOC increases.

At this time, the engine power input to the first motor generator 221 is the engine power Pm calculated by the formula 1, and the engine power input to the driving shaft 120 is the engine power Pd calculated by the formula 2.

When the own vehicle moving speed V reaches the upper limit speed Vupper at a time t61, an execution of the power charge optimum acceleration control is stopped, and an execution of the normal coasting control is started. Thus, the activation of the internal combustion engine 21 is stopped. Therefore, the engine output power becomes zero and as a result, the driving torque becomes zero. Further, the battery electricity consumption amount SOC_C increases and turns to a positive value. As a result, the battery-stored electricity amount SOC decreases. It should be noted that the battery electricity consumption amount SOC_C corresponds to the battery electricity consumed by the electric loads 40.

Thereby, the electricity is stored into the battery 231.

The vehicle moving control apparatus 10 may be configured to set a period of time for which the power charge optimum acceleration control is executed, to a long period of time when the battery-stored electricity amount SOC is small, compared with when the battery-stored electricity amount SOC is great at a point of time of starting to execute the power charge optimum acceleration control. In particular, in this embodiment, the vehicle moving control apparatus 10 may be configured to set the period of time for which the power charge optimum acceleration control is executed, to a period of time which increases as the battery-stored electricity amount SOC decreases at the point of time of starting to the execute the power charge optimum acceleration control.

Thereby, the period of time for which the power charge optimum is executed, is long when the battery-stored electricity amount SOC is small, compared with when the battery-stored electricity amount SOC is great. Thus, the enough amount of the electricity is stored into the battery 231 while the power charge optimum acceleration control is executed. Therefore, the battery-stored electricity amount can be prevented from becoming excessively small while the coasting control is executed.

It should be noted that the vehicle moving control apparatus 10 elongates the period of time for which the power charge optimum acceleration control is executed, by increasing the upper limit speed Vupper while the second moving speed control is executed. Further, the vehicle moving control apparatus 10 elongates the period of time for which the optimum acceleration control is executed, by decreasing the lower limit distance Dlower while the second inter-vehicle distance control is executed.

Furthermore, the predicted execution time T for which the power charge optimum acceleration control is executed, is long when the own vehicle 100 moves on an upward slope, compared with when the own vehicle 100 moves on a flat road. In addition, the predicted execution time T for which the power charge optimum acceleration control is predictively executed, is long when the own vehicle 100 moves on the upward slope, and a gradient is great, compared with when the own vehicle 100 moves on the upward slope, and the gradient is small.

Further, when the own vehicle moving speed V is great, the amount of the electricity acquired by the regeneration of the own vehicle moving energy is great. Therefore, the battery-stored electricity amount SOC can be sufficiently increased by generating the electricity by the regeneration of the own vehicle moving energy while the coasting control is executed later even when the generation of the electricity by the power generated by the power apparatus 20 is not performed while the acceleration control is executed. In this regard, when the generation of the electricity by the power generated by the power apparatus 20 is not performed, the amount of the energy consumed by the power apparatus 20 is reduced.

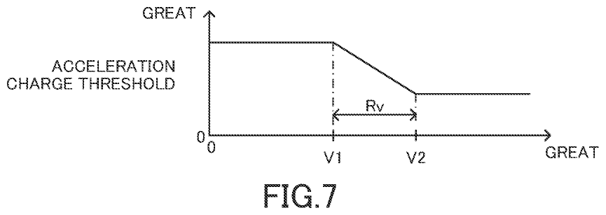

Accordingly, the vehicle moving control apparatus 10 sets the acceleration charge threshold SOC_A to a small value when the own vehicle moving speed V is great, compared with when the own vehicle moving speed V is small. In particular, the vehicle moving control apparatus 10 sets the acceleration charge threshold SOC_A to a value which decreases as the own vehicle moving speed V increases. In this embodiment, as shown in FIG. 7, the vehicle moving control apparatus 10 sets the acceleration charge threshold SOC_A to a value which decreases as the own vehicle moving speed V increases when the own vehicle moving speed V is within the predetermined range Rv. Further, when the own vehicle moving speed V is smaller than a lower limit value V1 of the predetermined range Rv, the vehicle moving control apparatus 10 sets the acceleration charge threshold SOC_A to a relatively great constant value. Furthermore, when the own vehicle moving speed V is greater than an upper limit value V2 of the predetermined range Rv, the vehicle moving control apparatus 10 sets the acceleration charge threshold SOC_A to a relatively small constant value.

Thereby, the acceleration charge threshold SOC_A is set to a small value when the own vehicle moving speed V is great, compared with when the own vehicle moving speed V is small. Therefore, the generation of the electricity by the power generated by the power apparatus 20 is not performed until the battery-stored electricity amount SOC becomes small when the own vehicle moving speed V is great while the acceleration control is executed. Thus, the battery-stored electricity amount SOC can be prevented from becoming excessively small, and the amount of the energy consumed by the power apparatus 20 can be reduced.

Similarly, the vehicle moving control apparatus 10 sets the first deceleration charge threshold SOC_D1 and the second deceleration charge threshold SOC_D2 to small values, respectively when the own vehicle moving speed V is great, compared with when the own vehicle moving speed V is small. In particular, the vehicle moving control apparatus 10 sets the first deceleration charge threshold SOC_D1 and the second deceleration charge threshold SOC_D2 to values, respectively which decrease as the own vehicle moving speed V increases. In this embodiment, the vehicle moving control apparatus 10 sets the first deceleration charge threshold SOC_D1 and the second deceleration charge threshold SOC_D2 to values, respectively which decrease as the own vehicle moving speed V increases when the own vehicle moving speed V is within a predetermined range. Further, when the own vehicle moving speed V is smaller than a lower limit value of the predetermined range, the vehicle moving control apparatus 10 sets the first deceleration charge threshold SOC_D1 and the second deceleration charge threshold SOC_D2 to relatively great constant values, respectively. Furthermore, when the own vehicle moving speed V is greater than an upper limit value of the predetermined range, the vehicle moving control apparatus 10 sets the first deceleration charge threshold SOC_D1 and the second deceleration charge threshold SOC_D2 to relatively small constant values, respectively.

Thereby, the first deceleration charge threshold SOC_D1 and the second deceleration charge threshold SOC_D2 are set to the small values, respectively when the own vehicle moving speed V is great, compared with when the own vehicle moving speed V is small. Therefore, the generation of the electricity by the power generated by the power apparatus 20 is not performed until the battery-stored electricity amount SOC becomes small when the own vehicle moving speed V is great while the coasting control is executed. Thus, the battery-stored electricity amount SOC can be prevented from becoming excessively small, and the amount of the energy consumed by the power apparatus 20 can be reduced.

Further, in a situation that the own vehicle 100 will move on the downward slope soon, even when the battery-stored electricity amount SOC becomes small while the acceleration control is executed, the enough amount of the electricity can be stored into the battery 231 by generating the electricity by the regeneration of the own vehicle moving energy while the own vehicle 100 moves on the downward slope later. Therefore, when the generation of the electricity by the power generated by the power apparatus 20 is not performed while the acceleration control is executed, the battery-stored electricity amount SOC can be sufficiently increased by generating the electricity by the regeneration of the own vehicle moving energy while the own vehicle 100 moves on the downward slope while the coasting control is executed later. In this regard, when the generation of the electricity by the power generated by the power apparatus 20 is not performed, the amount of the energy consumed by the power apparatus 20 is reduced.

Accordingly, the vehicle moving control apparatus 10 sets the acceleration charge threshold SOC_A to a small value when the own vehicle 100 is predicted to move on the downward slope, compared with when the own vehicle 100 is not predicted to move on the downward slope. The vehicle moving control apparatus 10 predicts whether the own vehicle 100 moves on the downward slope, based on a predicted moving route of the own vehicle 100 and the map information included in the surrounding detection information IS acquired by the road information acquisition device 70. The predicted moving route is a route along which the own vehicle 100 is predicted to move.

Thereby, the acceleration charge threshold SOC_A is set to a small value when the own vehicle 100 is predicted to move on the downward slope, compared with when the own vehicle 100 is not predicted to move on the downward slope. Therefore, the generation of the electricity by the power generated by the power apparatus 20 is not performed until the battery-stored electricity amount SOC becomes small when the own vehicle 100 is predicted to move on the downward slope while the acceleration control is executed. Thus, the battery-stored electricity amount SOC can be prevented from becoming excessively small, and the amount of the energy consumed by the power apparatus 20 can be reduced.

Similarly, the vehicle moving control apparatus 10 sets the first deceleration charge threshold SOC_D1 and the second deceleration charge threshold SOC_D2 to small values, respectively when the own vehicle 100 is predicted to move on the downward slope, compared with when the own vehicle 100 is not predicted to move on the downward slope. In this case, the vehicle moving control apparatus 10 also predicts whether the own vehicle 100 moves on the downward slope, based on the predicted moving route of the own vehicle 100 and the map information included in the surrounding detection information IS acquired by the road information acquisition device 70. The predicted moving route is a route along which the own vehicle 100 is predicted to move.

Thereby, the first deceleration charge threshold SOC_D1 and the second deceleration charge threshold SOC_D2 are set to the small values, respectively when the own vehicle 100 is predicted to move on the downward slope, compared with when the own vehicle 100 is not predicted to move on the downward slope. Therefore, the generation of the electricity by the power generated by the power apparatus 20 is not performed until the battery-stored electricity amount SOC becomes small when the own vehicle 100 is predicted to move on the downward slope while the coasting control is executed. Thus, the battery-stored electricity amount SOC can be prevented from becoming excessively small, and the amount of the energy consumed by the power apparatus 20 can be reduced.

The embodiment described above is one that the present invention is applied to the vehicle moving control apparatus which executes the coasting control while the second autonomous moving control is executed. In this regard, the present invention can be applied to the vehicle moving control apparatus which is configured to stop the activation of the power source such as the internal combustion engine and cause the vehicle to coast when the normal moving control is executed, and the accelerator pedal operation amount is zero, i.e., the driver releases the accelerator pedal.

<Specific Operations of Vehicle Moving Control Apparatus>

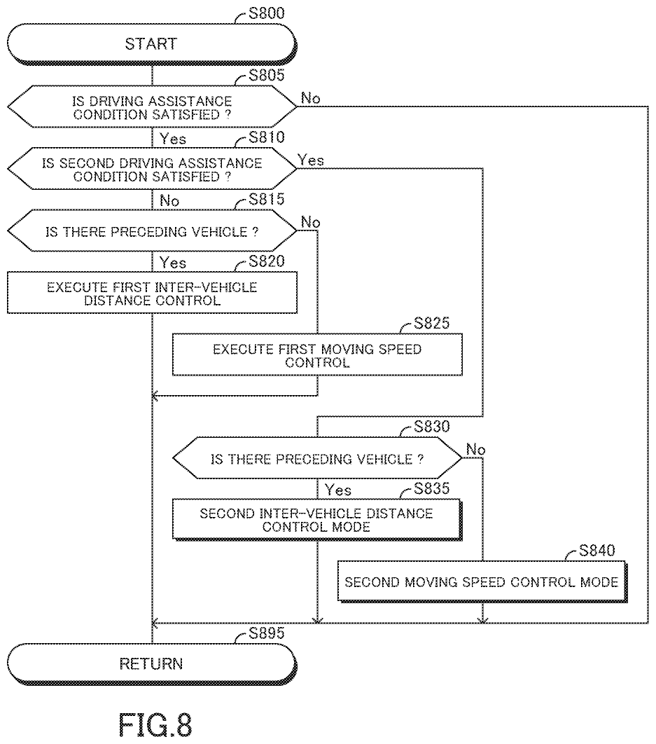

Next, specific operations of the vehicle moving control apparatus 10 will be described. The vehicle moving control apparatus 10 is configured to execute a routine shown in FIG. 8 with a predetermined calculation cycle. Therefore, at a predetermined timing, the vehicle moving control apparatus 10 starts a process from a step S800 of the routine shown in FIG. 8 and proceeds with the process to a step S805 to determine whether the driving assistance condition is satisfied.

When the vehicle moving control apparatus 10 determines “Yes” at the step S805, the vehicle moving control apparatus 10 proceeds with the process to a step S810 to determine whether the second driving assistance condition is satisfied. When the vehicle moving control apparatus 10 determines “No” at the step S810, the vehicle moving control apparatus 10 proceeds with the process to a step S815 to determine whether there is the preceding vehicle 200. When the vehicle moving control apparatus 10 determines “Yes” at the step S815, the vehicle moving control apparatus 10 proceeds with the process to a step S820 to execute the first inter-vehicle distance control. Next, the vehicle moving control apparatus 10 proceeds with the process to a step S895 to terminate executing this routine once.

On the other hand, when the vehicle moving control apparatus 10 determines “No” at the step S815, the vehicle moving control apparatus 10 proceeds with the process to a step S825 to execute the first moving speed control. Next, the vehicle moving control apparatus 10 proceeds with the process to the step S895 to terminate executing this routine once.

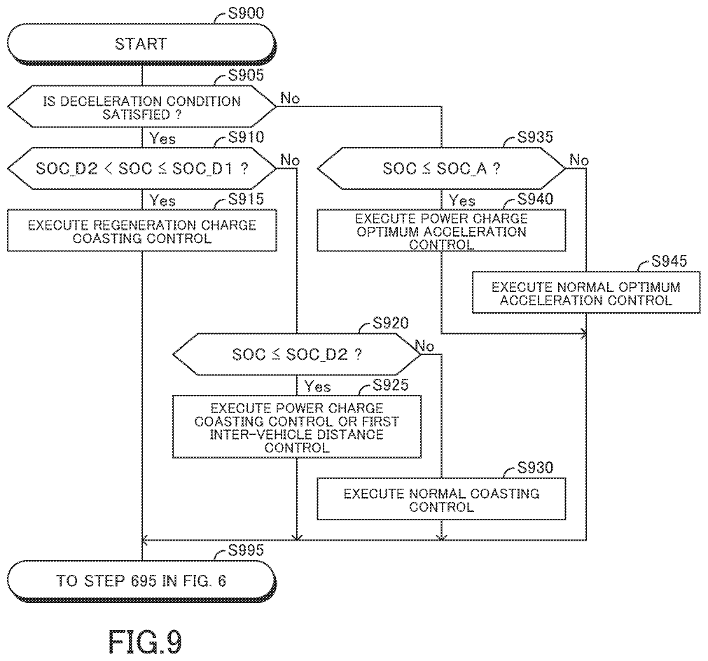

Further, when the vehicle moving control apparatus 10 determines “Yes” at the step S810, the vehicle moving control apparatus 10 proceeds with the process to a step S830 to determine whether there is the preceding vehicle 200. When the vehicle moving control apparatus 10 determines “Yes” at the step S830, the vehicle moving control apparatus 10 proceeds with the process to a step S835 to execute a routine shown in FIG. 9. Therefore, when the vehicle moving control apparatus 10 proceeds with the process to the step S835, the vehicle moving control apparatus 10 starts a process from a step S900 and proceeds with the process to a step S905 to determine whether the deceleration condition for the second inter-vehicle distance control is satisfied.

When the vehicle moving control apparatus 10 determines “Yes” at the step S905, the vehicle moving control apparatus 10 proceeds with the process to a step S910 to determine whether the battery-stored electricity amount SOC is greater than the second deceleration charge threshold SOC_D2 and equal to or smaller than the first deceleration charge threshold SOC_D1.

When the vehicle moving control apparatus 10 determines “Yes” at the step S910, the vehicle moving control apparatus 10 proceeds with the process to a step S915 to execute the regeneration charge coasting control. Next, the vehicle moving control apparatus 10 proceeds with the process to the step S895 through a step S995 to terminate executing this routine once.

On the other hand, when the vehicle moving control apparatus 10 determines “No” at the step S910, the vehicle moving control apparatus 10 proceeds with the process to a step S920 to determine whether the battery-stored electricity amount SOC is equal to or smaller than the second deceleration charge threshold SOC_D2.

When the vehicle moving control apparatus 10 determines “Yes” at the step S920, the vehicle moving control apparatus 10 proceeds with the process to a step S925 to execute the power charge coasting control or the first inter-vehicle distance control. Next, the vehicle moving control apparatus 10 proceeds with the process to the step S895 through the step S995 to terminate executing this routine once.

On the other hand, when the vehicle moving control apparatus 10 determines “No” at the step S920, the vehicle moving control apparatus 10 proceeds with the process to a step S930 to execute the normal coasting control. Next, the vehicle moving control apparatus 10 proceeds with the process to the step S895 through the step S995 to terminate executing this routine once.

Further, when the vehicle moving control apparatus 10 determines “No” at the step S905, the vehicle moving control apparatus 10 proceeds with the process to a step S935 to determine whether the battery-stored electricity amount SOC is equal to or smaller than the acceleration charge threshold SOC_A.

When the vehicle moving control apparatus 10 determines “Yes” at the step S935, the vehicle moving control apparatus 10 proceeds with the process to a step S940 to execute the power charge optimum acceleration control. Next, the vehicle moving control apparatus 10 proceeds with the process to the step S895 through the step S995 to terminate executing this routine once.

On the other hand, when the vehicle moving control apparatus 10 determines “No” at the step S935, the vehicle moving control apparatus 10 proceeds with the process to a step S945 to execute the normal optimum acceleration control. Next, the vehicle moving control apparatus 10 proceeds with the process to the step S895 through the step S995 to terminate executing this routine once.

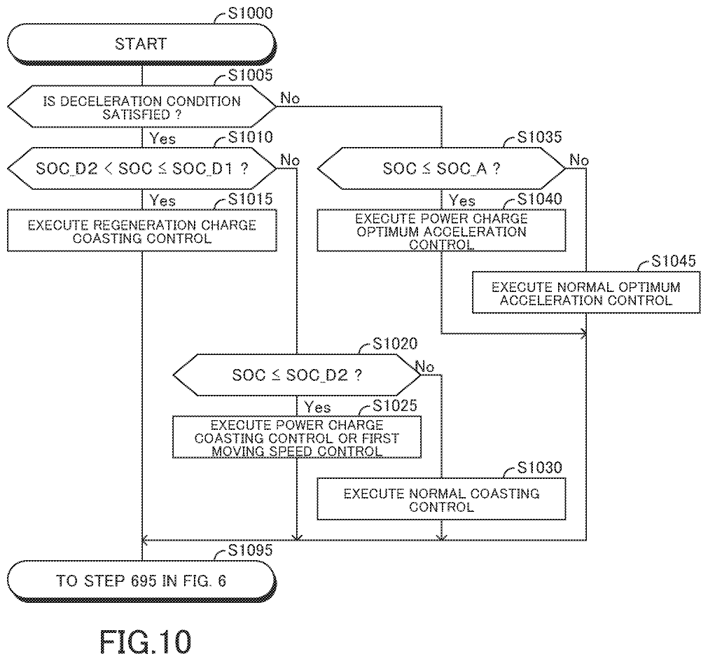

On the other hand, when the vehicle moving control apparatus 10 determines “No” at the step S830 of the routine shown in FIG. 8, the vehicle moving control apparatus 10 proceeds with the process to a step S840 to execute a routine shown in FIG. 10. Therefore, when the vehicle moving control apparatus 10 proceeds with the process to the step S840, the vehicle moving control apparatus 10 starts a process from a step S1000 of the routine shown in FIG. 10 and proceeds with the process to a step S1005 to determine whether the deceleration condition for the second moving speed control is satisfied.

When the vehicle moving control apparatus 10 determines “Yes” at the step S1005, the vehicle moving control apparatus 10 proceeds with the process to a step S1010 to determine whether the battery-stored electricity amount SOC is greater than the second deceleration charge threshold SOC_D2 and equal to or smaller than the first deceleration charge threshold SOC_D1.

When the vehicle moving control apparatus 10 determines “Yes” at the step S1010, the vehicle moving control apparatus 10 proceeds with the process to a step S1015 to execute the regeneration charge coasting control. Next, the vehicle moving control apparatus 10 proceeds with the process to the step S895 through a step S1095 to terminate executing this routine once.

On the other hand, when the vehicle moving control apparatus 10 determines “No” at the step S1010, the vehicle moving control apparatus 10 proceeds with the process to a step S1020 to determine whether the battery-stored electricity amount SOC is equal to or smaller than the second deceleration charge threshold SOC_D2.

When the vehicle moving control apparatus 10 determines “Yes” at the step S1020, the vehicle moving control apparatus 10 proceeds with the process to a step S1025 to execute the power charge coasting control or the first moving speed control. Next, the vehicle moving control apparatus 10 proceeds with the process to the step S895 through the step S1095 to terminate executing this routine once.

On the other hand, when the vehicle moving control apparatus 10 determines “No” at the step S1020, the vehicle moving control apparatus 10 proceeds with the process to a step S1030 to execute the normal coasting control. Next, the vehicle moving control apparatus 10 proceeds with the process to the step S895 through the step S1095 to terminate executing this routine once.

Further, when the vehicle moving control apparatus 10 determines “No” at the step S1005, the vehicle moving control apparatus 10 proceeds with the process to a step S1035 to determine whether the battery-stored electricity amount SOC is equal to or smaller than the acceleration charge threshold SOC_A.

When the vehicle moving control apparatus 10 determines “Yes” at the step S1035, the vehicle moving control apparatus 10 proceeds with the process to a step S1040 to execute the power charge optimum acceleration control. Next, the vehicle moving control apparatus 10 proceeds with the process to the step S895 through the step S1095 to terminate executing this routine once.

On the other hand, when the vehicle moving control apparatus 10 determines “No” at the step S1035, the vehicle moving control apparatus 10 proceeds with the process to a step S1045 to execute the normal optimum acceleration control. Next, the vehicle moving control apparatus 10 proceeds with the process to the step S895 through the step S1095 to terminate executing this routine once.

The specific operations of the vehicle moving control apparatus 10 have been described.

It should be noted that the invention is not limited to the aforementioned embodiments, and various modifications can be employed within the scope of the invention.

What is claimed is:

1. A vehicle moving control apparatus, comprising an electronic control unit configured to execute an autonomous moving control for autonomously accelerating or decelerating a vehicle,
the autonomous moving control including an acceleration control and a coasting control,
the acceleration control being a control to accelerate the vehicle by (i) activating a power source of the vehicle to generate power and (ii) accelerating the vehicle by the generated power, and
the coasting control being a control to cause the vehicle to coast by stopping an activation of the power source,
wherein the electronic control unit is configured to:
execute a regeneration charge coasting control as the coasting control when a stored amount of electricity stored in an electricity storage device of the vehicle is equal to or smaller than a first deceleration charge threshold while a deceleration condition for decelerating the vehicle is satisfied,
the regeneration charge coasting control being a control to cause the vehicle to coast and store the electricity into the electricity storage device by (i) stopping the activation of the power source, (ii) performing a regeneration of moving energy of the vehicle by an electricity generation device of the vehicle to generate the electricity, and (iii) storing the generated electricity into the electricity storage device; and
execute a normal coasting control as the coasting control when the stored amount of the electricity is greater than the first deceleration charge threshold while the deceleration condition is satisfied,
the normal coasting control being a control to cause the vehicle to coast by stopping the activation of the power source without performing the regeneration of the moving energy of the vehicle.

2. The vehicle moving control apparatus as set forth in claim 1,
wherein the electronic control unit is configured to:
execute a power charge moving control when the stored amount of the electricity is equal to or smaller than a second deceleration charge threshold smaller than the first deceleration charge threshold while the deceleration condition is satisfied,
the power charge moving control being a control to cause the vehicle to move by (i) activating the power source to generate the power, (ii) activating the electricity generation device by the generated power to generate the electricity, and (iii) storing the generated electricity into the electricity storage device; and
execute the regeneration charge coasting control when the stored amount of the electricity is equal to or smaller than the first deceleration charge threshold and greater than the second deceleration charge threshold while the deceleration condition is satisfied.

3. The vehicle moving control apparatus as set forth in claim 1, wherein the electronic control unit is configured to execute the regeneration charge coasting control so as to store an amount of the electricity depending on an amount of the electricity consumed from the electricity storage device by at least one electric load of the vehicle.

4. The vehicle moving control apparatus as set forth in claim 1, wherein the electronic control unit is configured to limit a generated amount of the electricity generated by the regeneration of the moving energy of the vehicle by the electricity generation device so as to maintain a deceleration rate of the vehicle equal to or smaller than a predetermined deceleration rate while the regeneration charge coasting control is executed.

5. The vehicle moving control apparatus as set forth in claim 1,
wherein the power source includes an internal combustion engine,
wherein the electronic control unit is configured to execute a power charge acceleration control as the acceleration control when the stored amount of the electricity is equal to or smaller than an acceleration charge threshold while an acceleration condition for accelerating the vehicle is satisfied,
the power charge acceleration control being a control to accelerate the vehicle and store the electricity into the electricity storage device by (i) activating the internal combustion engine to generate the power, (ii) activating the electricity generation device to generate the electricity by a part of the generated power, (iii) storing the generated electricity into the electricity storage device, and (iv) accelerating the vehicle by the remaining generated power, and
wherein the electronic control unit is configured to extend a time of executing the power charge acceleration control such that the time of executing the power charge acceleration control increases as the stored amount of the electricity decreases.

6. The vehicle moving control apparatus as set forth in claim 5, wherein the electronic control unit is configured to set the acceleration charge threshold such that the acceleration charge threshold decreases as a moving speed of the vehicle increases.

7. The vehicle moving control apparatus as set forth in claim 5, wherein the electronic control unit is configured to set the acceleration charge threshold such that the acceleration charge threshold when the vehicle is predicted to move on a downward slope, based on map information and a predicted moving route of the vehicle, is smaller than the acceleration charge threshold when the vehicle is not predicted to move on the downward slope, based on the map information and the predicted moving route of the vehicle.

8. The vehicle moving control apparatus as set forth in claim 1,
wherein the electronic control unit is configured to execute a power charge acceleration control as the acceleration control when the stored amount of the electricity is equal to or smaller than an acceleration charge threshold while an acceleration condition for accelerating the vehicle is satisfied,
the power charge acceleration control being a control to accelerate the vehicle and store the electricity into the electricity storage device by (i) activating the power source to generate the power, (ii) activating the electricity generation device to generate the electricity by a part of the generated power, (iii) storing the generated electricity into the electricity storage device, and (iv) accelerating the vehicle by the remaining generated power.

9. A vehicle moving control method of executing an autonomous moving control for autonomously accelerating or decelerating a vehicle,
the autonomous moving control including an acceleration control and a coasting control,
the acceleration control being a control to (i) activate a power source of the vehicle to generate power and (ii) accelerate the vehicle by the generated power, and
the coasting control being a control to (i) stop activating the power source and (ii) cause the vehicle to coast,
wherein the vehicle moving control method comprises:
a step of executing a regeneration charge coasting control as the coasting control when a stored amount of electricity stored in an electricity storage device of the vehicle is equal to or smaller than a first deceleration charge threshold while a deceleration condition for decelerating the vehicle is satisfied,
the regeneration charge coasting control being a control to (i) stop activating the power source and cause the vehicle to coast, (ii) generate the electricity by performing a regeneration of moving energy of the vehicle by an electricity generation device of the vehicle, and (iii) store the generated electricity into the electricity storage device; and
a step executing a normal coasting control as the coasting control when the stored amount of the electricity is greater than the first deceleration charge threshold while the deceleration condition is satisfied,
the normal coasting control being a control to (i) stop activating the power source and cause the vehicle to coast without performing the regeneration of the moving energy of the vehicle.

10. A computer-readable storage medium storing a vehicle moving control program which executes an autonomous moving control for autonomously accelerating or decelerating a vehicle,
the autonomous moving control including an acceleration control and a coasting control,
the acceleration control being a control to (i) activate a power source of the vehicle to generate power and (ii) accelerate the vehicle by the generated power, and
the coasting control being a control to (i) stop activating the power source and (ii) cause the vehicle to coast,
wherein the vehicle moving control program is configured to:
execute a regeneration charge coasting control as the coasting control when a stored amount of electricity stored in an electricity storage device of the vehicle is equal to or smaller than a first deceleration charge threshold while a deceleration condition for decelerating the vehicle is satisfied,
the regeneration charge coasting control being a control to (i) stop activating the power source and cause the vehicle to coast, (ii) generate the electricity by performing a regeneration of moving energy of the vehicle by an electricity generation device of the vehicle, and (iii) store the generated electricity into the electricity storage device; and
execute a normal coasting control as the coasting control when the stored amount of the electricity is greater than the first deceleration charge threshold while the deceleration condition is satisfied,
the normal coasting control being a control to (i) stop activating the power source and cause the vehicle to coast without performing the regeneration of the moving energy of the vehicle.
